(19) United States
(12) Patent Application Publication
(10) Pub. No.: US 2010/0034268 A1
(43) Pub. Date: Feb. 11, 2010

(54) IMAGE CODING DEVICE AND IMAGE DECODING DEVICE

(76) Inventors: Toshihiko Kusakabe, Osaka (JP); Akihiko Inoue, Fukuoka (JP)

Correspondence Address: WENDEROTH, LIND & PONACK L.L.P., 1030 15th Street, N.W., Suite 400 East, Washington, DC, 20005-1503, US

(21) Appl. No.: 12/515,647

(22) PCT Filed: Sep. 17, 2008
(86) PCT No.: PCT/JP2008/002552

§ 371 Date: May 20, 2009

(30) Foreign Application Priority Data
Sep. 21, 2007 (JP) 2007-244827

(51) Int. Cl. H04N 7/50

(52) U.S. Cl. 375/240.15; 375/E07.224

(57) ABSTRACT

There is a problem of increasing image quality deterioration when selection of an intra prediction mode for a face outline portion is not correct at a low bit-rate. This invention includes: a face detection unit detecting a face image from an input picture; and an intra prediction mode control unit controlling intra prediction mode selection based on a result of the detection of the face detection unit. In the control of intra prediction mode selection, an intra prediction mode is selected based on where a current block is positioned in a region of the face image. Thereby, an appropriate intra prediction mode can be selected for the face outline portion. As a result, image quality deterioration on the face image at a low bit-rate can be prevented.

### TECHNICAL FIELD

The present invention relates to image coding devices and image decoding devices for detecting an image of a face from an input image and using a result of the detection in coding and decoding the input image.

### BACKGROUND ART

There is a standard technology of coding video data, known as “MPEG-4 Part 10: Advanced Video Coding (MPEG-4 AVC)” established by Moving Picture Experts Group (MPEG) of Joint Technical Committee 1 of the International Organization for Standardization and the International Electrotechnical Commission (ISO/IEC JTC 1). This MPEG-4 AVC employs intra prediction by which prediction is performed using neighbor pixels in a target frame for intra-frame coding. In the intra-frame coding, prediction coding is performed with reference to only pixels in the same frame.

The intra prediction of MPEG-4 AVC uses different modes for luminance components and chrominance components.

For luminance components, intra prediction modes are classified into (i) a 16×16 intra prediction mode at which intra prediction is performed in units of blocks each having 16×16 pixels and (ii) a 4×4 intra prediction mode at which intra prediction is performed in units of blocks each having 4×4 pixels.

On the other hand, for chrominance components, there is only one intra prediction mode that is an 8×8 intra prediction mode at which intra prediction is performed in units of blocks each having 8×8 pixels.

FIG. 1 (a) to (d) are diagrams showing methods of calculating a prediction value from neighbor pixels at the 16×16 intra prediction mode. The 16×16 intra prediction mode is classified into four prediction modes that are “Mode 0: Vertical” (vertical prediction mode) shown in FIG. 1 (a), “Mode 1: Horizontal” (horizontal prediction mode) shown in FIG. 1(b), “Mode 2: DC” (DC prediction mode) shown in FIG. 1 (c), and “Mode 3: Plane” (plane prediction mode) shown in FIG. 1 (d).

FIG. 2 (a) to (i) are diagrams showing methods of calculating a prediction value from neighbor pixels A to M at the 4×4 intra prediction mode. The 4×4 intra prediction mode is classified into nine prediction modes as shown in FIG. 2 (a) to (i).

In coding processing, it is necessary to select a suitable mode from these intra prediction modes for each of luminance components and chrominance components. In general, in order to select a suitable intra prediction mode, a differential value indicating a difference between a prediction value of a corresponding intra prediction mode and image signals is evaluated for each of the intra prediction modes, and an intra prediction mode having an optimum result of the evaluation is selected to be used.

Moreover, Patent References 1 and 2 disclose other methods for selecting one of intra prediction modes.

Patent References 1 discloses that a pattern of a divided block is evaluated to select an intra prediction mode. FIG. 3 is a diagram of an intra prediction unit in an image coding device disclosed in Patent Reference 1. The intra prediction unit of Patent Reference 1 includes: a block division unit 101 dividing an input image into blocks; an image pattern determination unit 102 determining an image pattern of the divided block; an intra prediction mode control unit 103 controlling an intra prediction mode based on the determined pattern; a selector 104 selecting the intra prediction mode designated by the intra prediction mode control unit 103; a vertical intra prediction mode unit 105 performing intra prediction at a vertical prediction mode; a horizontal intra prediction mode unit 106 performing intra prediction at a horizontal prediction mode; and a DC intra prediction mode unit 107 performing intra prediction at a DC prediction mode.

By this method, the image pattern determination unit 102 performs Hadamard transform on pixel data of a block and evaluates frequency components, in order to determine a direction of an edge included in the block. Based on a result of the determination, the intra prediction mode control unit 103 selects an intra prediction mode.

Patent Reference 2 discloses a method of restricting selectable intra prediction modes using information indicating a frame/field structure or the like regarding an entire picture, so that an intra prediction mode to be used is selected only from the selectable intra prediction modes. FIG. 4 (a) is a diagram showing prediction directions of three intra prediction modes when a picture has a field structure. FIG. 4 (b) is a diagram showing a change in the prediction directions of the three intra prediction modes of FIG. 4 (a) when scan lines of interlaced scanning are applied on an original picture. For example, as shown in FIG. 4 (a), when a picture has a field structure, a difference of an angle of a prediction direction between “Mode 0: Vertical” and “Mode 5: Vertical-Right” or “Mode 7: Vertical Left” in the 4×4 intra prediction is 22.5 degrees. However, in the original picture before eliminating one pixel by the interlaced scanning, the angle of the prediction direction between “Mode 0” and “Mode 5” or “Mode 7” is decreased to a half as shown in FIG. 4 (b). Thereby, the prediction directions of “Mode 5” and “Mode 7” are closer to a vertical line. Therefore, it is considered that in a field structure a prediction error between “Mode 0” and “Mode 5” or “Mode 7” is small. From the above reason, when a picture has a field structure and the 4×4 intra prediction is used, the intra prediction modes of “Mode 5” and “Mode 7” are eliminated from the selectable intra prediction modes, before determining (selecting) a suitable intra prediction mode. Thereby, it is possible to reduce a processing amount for the determination processing performed by the intra prediction device for determining an intra prediction mode.

In intra-frame coding of MPEG-4 AVC, a difference image between (i) each of images (blocks) generated by dividing an input image and (ii) a prediction image generated by intra prediction using the above-described prediction mode is calculated. Then, orthogonal transformation and quantization are performed on the difference image to generate quantization coefficients. The quantization coefficients are applied with entropy coding to generate a coded stream. On the other hand, in decoding processing, entropy decoding is performed on the coded stream to generate quantization coefficients. Then, inverse quantization and inverse orthogonal transformation are performed on the quantization coefficients to generate the difference image. The generated difference image is added with the prediction image generated by the intra prediction. As a result, a decoded image is generated.

When this MPEG-4 AVC is used in a network camera requiring a low bit-rate, influence of quantization error in the prediction image by the intra prediction to the decoded image is increased, because a bit amount which can be allocated to a difference image of each block is not enough at the low bit-rate.

In the above situation, if the selected intra prediction mode is not appropriate, the resulting decoded image is significantly deteriorated. Especially deterioration occurring on an outline of an image of a face (hereinafter, referred to simply as a “face” of “face image”) is significant subjective deterioration of image quality. Therefore, an appropriate intra prediction mode needs to be selected for an outline of a face image.

### Patent Reference 1: Japanese Unexamined Patent Application Publication No. 2006-5659

### Patent Reference 2: Japanese Unexamined Patent Application Publication No. 2006-186972

### DISCLOSURE OF INVENTION

### Problems that Invention is to Solve

Unfortunately, these conventional methods of selecting an intra prediction mode fail to select an appropriate intra prediction mode for an outline of a face image.

In the method disclosed in Patent Reference 1, an image pattern of each block is evaluated. Therefore, even when a block to be evaluated includes a portion of an outline of a face image, if horizontal edge components of a background image are prominent, an intra prediction mode in a horizontal direction along to an edge of the background image is selected. Thereby, a horizontal edge caused by a prediction image horizontally predicted from the background image appears especially in an outline, especially in a cheek, of the face image. As a result, image quality is deteriorated with an edge of the background image extended to a direction across the outline of the face image, for example.

Furthermore, in the method disclosed in Patent Reference 2, an intra prediction mode is selected on picture basis. Therefore, it is impossible to restrict selectable intra prediction modes only for a periphery of the face image. As a result, the method of Patent Reference 2 is not effective to prevent deterioration of an outline of a face image.

The present invention overcomes the above-described problems. It is an object of the present invention to provide an image coding device and an image decoding device with less subjective deterioration of image quality while increasing image compression efficiency.

### Means to Solve the Problems

In accordance with the first aspect of the present invention for solving the conventional problems, there is provided an image coding device performing prediction coding including intra prediction, the image coding device including: an object detection unit configured to detect an object image from an input picture; an intra prediction mode selection unit configured to (i) divide the input picture into blocks, and (ii) select, for one of the blocks, one of intra prediction modes which corresponds to a direction of a portion of an outline of the object image, when the one of the blocks includes the portion of the outline; and an intra prediction unit configured to perform intra prediction on the one of the blocks at the one of the intra prediction modes which is selected by the intra prediction mode selection unit.

In accordance with the second aspect of the present invention, there is provided an image decoding device performing prediction decoding including intra prediction, the image decoding device including: an object detection unit configured to detect an object image from a decoded picture generated from input coded data; an intra prediction mode selection unit configured to select, for a current block in a current picture, an intra prediction mode corresponding to a direction of a portion of an outline of the object image detected from the decoded picture, when the current block is co-located with a block which is in the decoded picture and includes the portion of the outline; and an intra prediction unit configured to perform intra prediction of the current block at the intra prediction mode selected by the intra prediction mode selection unit.

### EFFECTS OF THE INVENTION

With the above structure, the present invention can select an appropriate intra prediction mode for an outline of a face image even with a low bit-rate. As a result, it is possible to reduce subjective deterioration of image quality.

### BRIEF DESCRIPTION OF DRAWINGS

FIG. 1 (a) to (d) are diagrams showing prediction methods of 16×16 intra prediction modes.

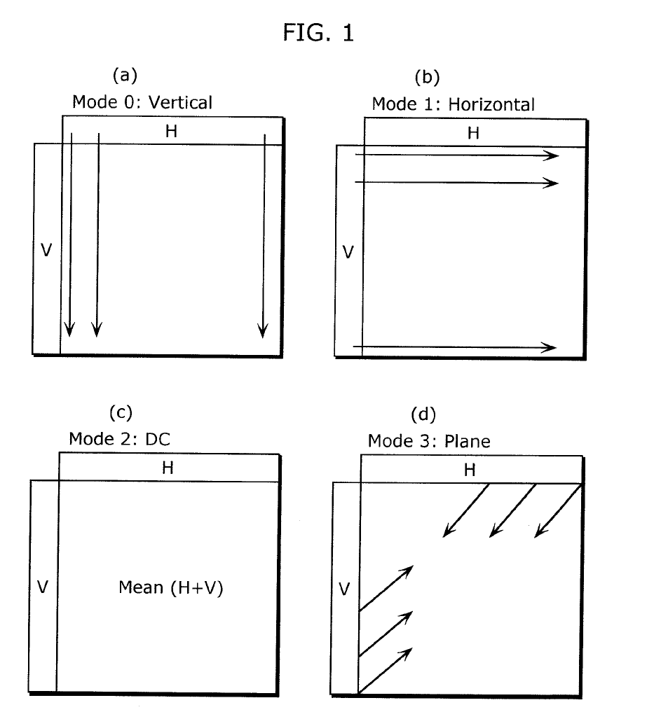

FIG. 2 (a) to (i) are diagrams showing prediction methods of 4×4 intra prediction modes.

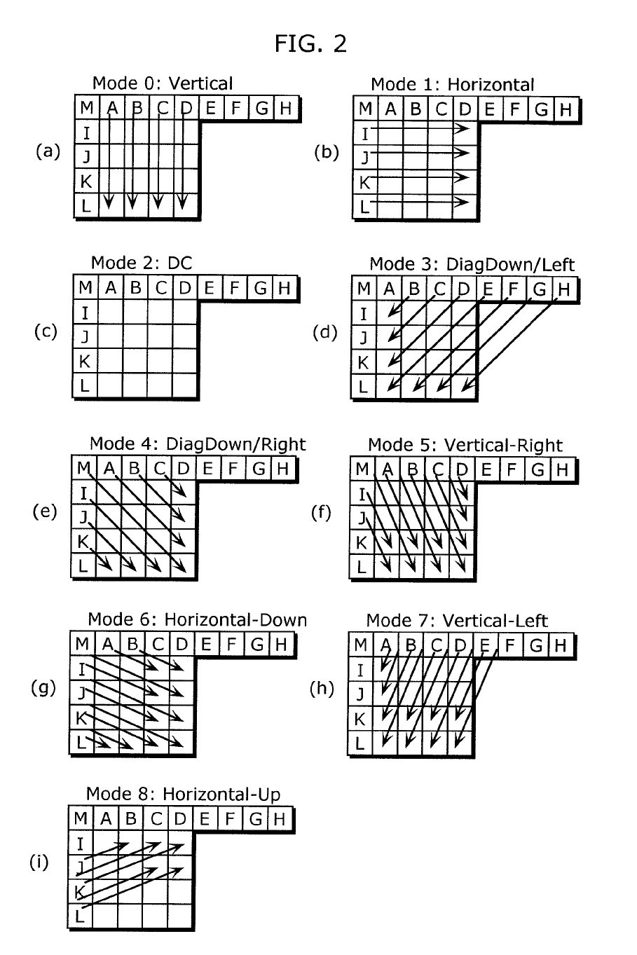

FIG. 3 is a block diagram of an intra prediction unit in a conventional image coding device.

FIGS. 4 (a) and (b) are diagrams showing prediction directions in a conventional field structure and prediction directions in an original picture, respectively.

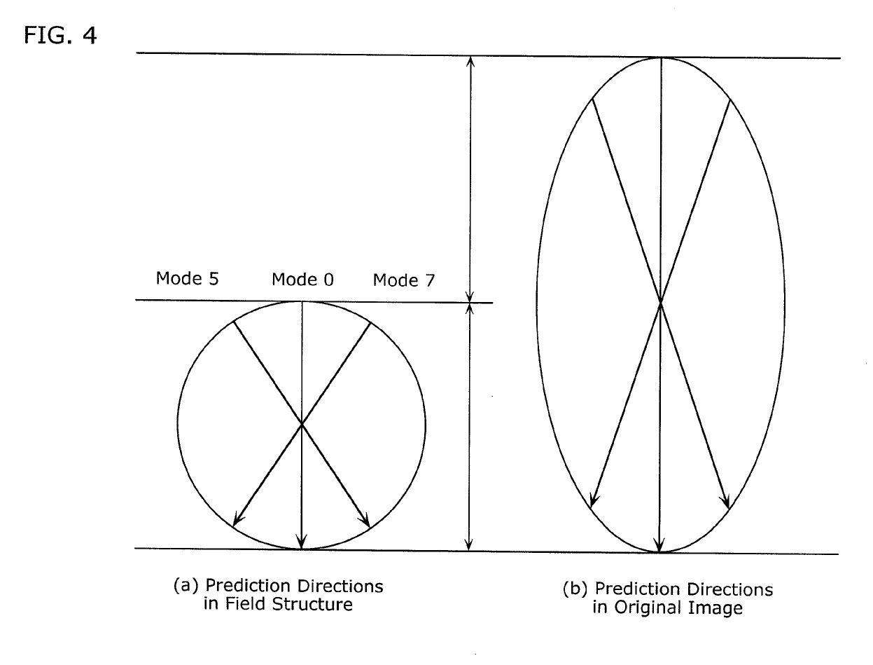

FIG. 5 is a block diagram of an image coding device according to Embodiment 1 of the present invention.

FIG. 6 is a block diagram of an intra prediction unit according to Embodiment 1.

FIG. 7 is a diagram showing a region detected by a face detection unit.

FIG. 8 is a flowchart of intra prediction mode determination performed by an intra prediction mode control unit.

FIG. 9 is a diagram showing an enlarged face image region and how to select an intra prediction mode for a current block including a boundary of a face image region.

FIG. 10 is a block diagram of an image decoding device according to Embodiment 2 of the present invention.

FIG. 11 is a flowchart of processing performed by the image decoding device to perform intra prediction according to a direction of a boundary of a face image region.

### NUMERICAL REFERENCES

101, 801 block division unit
102 image pattern determination unit
103 intra prediction mode control unit
104, 812, 906 selector
105 vertical intra prediction mode unit
106 horizontal intra prediction mode unit
107 DC intra prediction mode unit
110, 813, 911 face detection unit
501 input picture
502 face image region
701 block
702 block
800 image coding device
802 orthogonal transformation unit
803 quantization unit
804 entropy coding unit
805, 902 inverse quantization unit
806, 903 inverse orthogonal transformation unit
807, 905 loop filter
808 first picture memory
809, 907 intra prediction unit
810 second picture memory
811, 908 inter prediction unit
900 image decoding device
901 entropy decoding unit
909 third picture memory
910 fourth picture memory

### BEST MODE FOR CARRYING OUT THE INVENTION

The following describes embodiments of the present invention with reference to the drawings.

### Embodiment 1

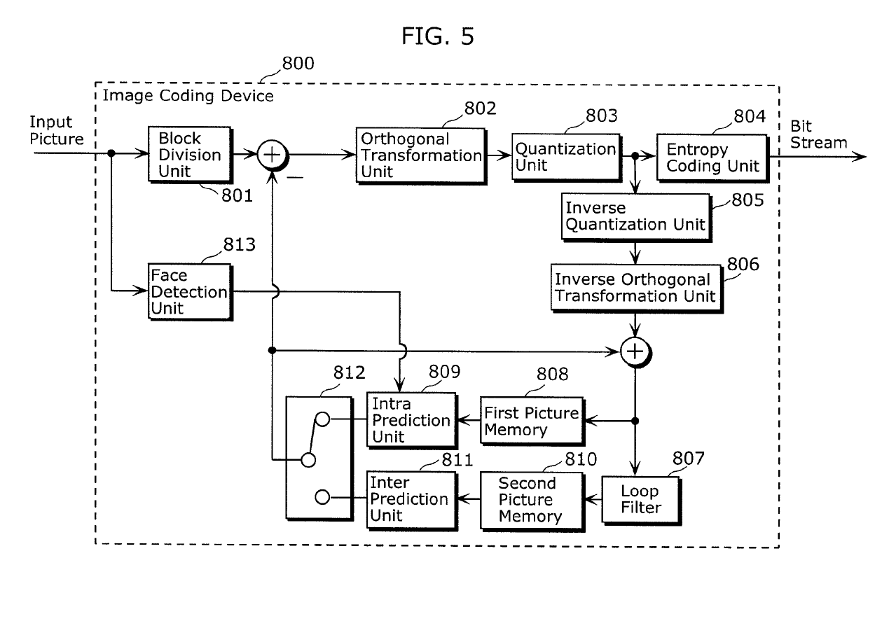

FIG. 5 is a block diagram of an image coding device 800 according to Embodiment 1 of the present invention.

The image coding device 800 according to Embodiment 1 detects an outline of a face in an input picture and specifies a rectangular region including the face (hereinafter, referred to as a “face image region”). Then, the image coding device 800 selects a vertical intra prediction mode for a current block including a part of a vertical boundary of the specified face image region, and selects a horizontal intra prediction mode for a current block including a part of a horizontal boundary of the specified face image region. The image coding device 800 includes a block division unit 801, an orthogonal transformation unit 802, a quantization unit 803, an entropy coding unit 804, an inverse quantization unit 805, an inverse orthogonal transformation unit 806, a loop filter 807, a first picture memory 808, an intra prediction unit 809, a second picture memory 810, an inter prediction unit 811, and a selector 812. The block division unit 801 divides an input picture into blocks. The orthogonal transformation unit 802 performs orthogonal transformation on each of the blocks. The quantization unit 803 performs quantization on a transformed coefficient generated by the orthogonal transformation unit 802. The entropy coding unit 804 codes the quantized coefficient generated by the quantization unit 803. The inverse quantization unit 805 performs inverse quantization on the quantized coefficient generated by the quantization unit 803. The inverse orthogonal transformation unit 806 performs inverse orthogonal transformation on the transformed coefficient generated by the inverse quantization unit 805. The image generated by the inverse orthogonal transformation unit 806 is added with a prediction image and then stored into the first picture memory 808. The intra prediction unit 809 performs intra prediction using pixels in the same input picture stored in the first picture memory 808, thereby generating a prediction image. Here, the intra prediction unit 809 is an example of “an intra prediction unit configured to perform intra prediction on the one of the blocks at the one of the intra prediction modes which is selected by the intra prediction mode selection unit” in the first aspect of the present invention. The loop filter 807 performs de-blocking filtering on the image generated by adding the image generated by the inverse orthogonal transformation unit 806 with the prediction image. The second picture memory 810 stores the image applied with the de-blocking filtering by the loop filter 807. The inter prediction unit 811 performs inter-frame prediction with reference to the image stored in the second picture memory 810, thereby generating a different prediction image. The selector 812 selects between (i) the prediction image generated by the intra prediction unit 809 and (ii) the prediction image generated by the inter prediction unit 811. The face detection unit 813 is an example of “an object detection unit configured to detect an object image from an input picture”, “the object detection unit is configured to detect a face as the object image”, and “the object detection unit is further configured to generate region information indicating a region including the detected object image in the input picture” described in the first aspect of the present invention. The face detection unit 813 detects a face from the input picture and provides a result of the detection to the intra prediction unit 809.

The following describes a block to be applied with the intra prediction by the image coding device 800.

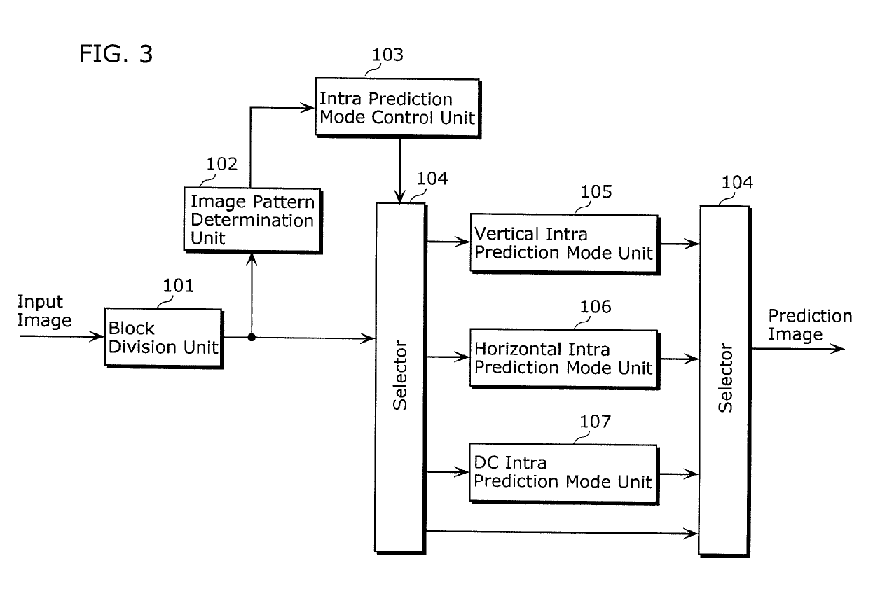

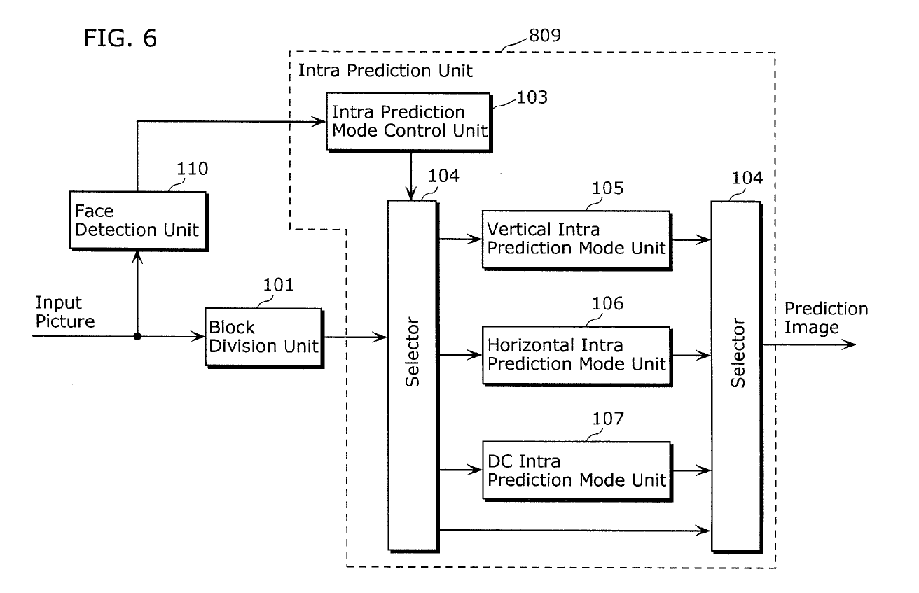

FIG. 6 is a block diagram of the intra prediction unit 809 and the face detection unit 813 in the image coding device 800 according to Embodiment 1. Here, the same reference numerals of FIG. 3 are assigned to the identical units of FIG. 6, so that the identical units are not explained again below. It should be noted that FIG. 6 does not show a subtractor, the orthogonal transformation unit 802, the quantization unit 803, the inverse quantization unit 805, the inverse orthogonal transformation unit 806, the adder, and the first picture memory 808, all of which actually exist between a block division unit 101 to the selector 104. It should also be noted that the face detection unit 813 and the block division unit 801 of FIG. 5 are identical to the face detection unit 110 and the block division unit 101 of FIG. 6, respectively.

The intra prediction unit 809 of Embodiment 1 includes the block division unit 101, the intra prediction mode control unit 103, the selectors 104, the vertical intra prediction mode unit 105, the horizontal intra prediction mode unit 106, and the DC intra prediction mode unit 107. The face detection unit 110 detects a face from an input picture and generates information regarding a region of the detected face (hereinafter, referred to as “face image region information”). The block division unit 101 divides the input picture into blocks each having a size predetermined according to units of the intra prediction. Based on the face image region information generated by the face detection unit 110, the intra prediction mode control unit 103 selects an intra prediction mode for a current block. Here, the block division unit 101 and the intra prediction mode control unit 103 are an example of “an intra prediction mode selection unit configured to (i) divide the input picture into blocks, and (ii) select, for one of the blocks, one of intra prediction modes which corresponds to a direction of a portion of an outline of the object image, when the one of the blocks includes the portion of the outline” in the first aspect of the present invention. The intra prediction mode control unit 103 is an example of “the intra prediction mode selection unit is configured to select the one of the intra prediction modes assuming that an outline of the region indicated by the region information is the outline of the object image” in the first aspect of the present invention. The selector 104 switches an intra prediction mode to another according to instructions from the intra prediction mode control unit 103. The vertical intra prediction mode unit 105 performs intra prediction on the current block at the vertical intra prediction mode. The horizontal intra prediction mode unit 106 performs intra prediction on the current block at the horizontal intra prediction mode. The DC intra prediction mode unit 107 performs intra prediction on the current block at the DC intra prediction mode using an arithmetic average of pixel values.

In FIG. 6, the face detection unit 110 detects a face from an input picture and provides face image region information to the intra prediction mode control unit 103. For example, the face may be detected using template matching. It is also possible to use a knowledge regarding faces, for example, using information of skin colors or paying attention to parts in a face. There is also an example-based face detection method by which a large number of face images and non-face images are prepared as training samples and thereby a recognizer for detecting a face is structured by learning.

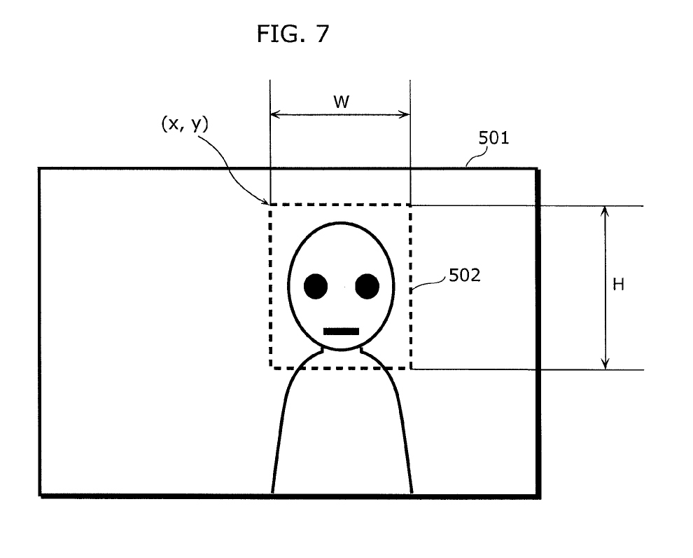

FIG. 7 is a diagram showing an example of face image region information generated by the face detection unit 110. The intra prediction mode control unit 103 designates an intra prediction mode based on face image region information indicating a region 502 including a face image detected from an input picture 501 by the face detection unit 110. Here, the intra prediction mode control unit 103 designates, for example, one of the vertical intra prediction mode unit 105, the horizontal intra prediction mode unit 106, the DC intra prediction mode unit 107, and no intra prediction. The face image region information generated by the face detection unit 110 is an example of “the region information indicates (i) coordinates of a starting point of the region and (ii) a size of the region” in the first aspect of the present invention. As shown in FIG. 7, the face image region information is represented by start coordinates (x, y), a width W, and a height H of the face image region 502. In Embodiment 1, using the pieces of data regarding the face image region, a position of a currently-processing block (current block) is determined in the face image region, and thereby an intra prediction mode is selected. Here, especially for a block including a portion of an outline of the face image, intra prediction modes candidates causing deterioration are prevented (restricted) from being selected. As a result, it is possible to prevent image quality deterioration due to a low bit-rate.

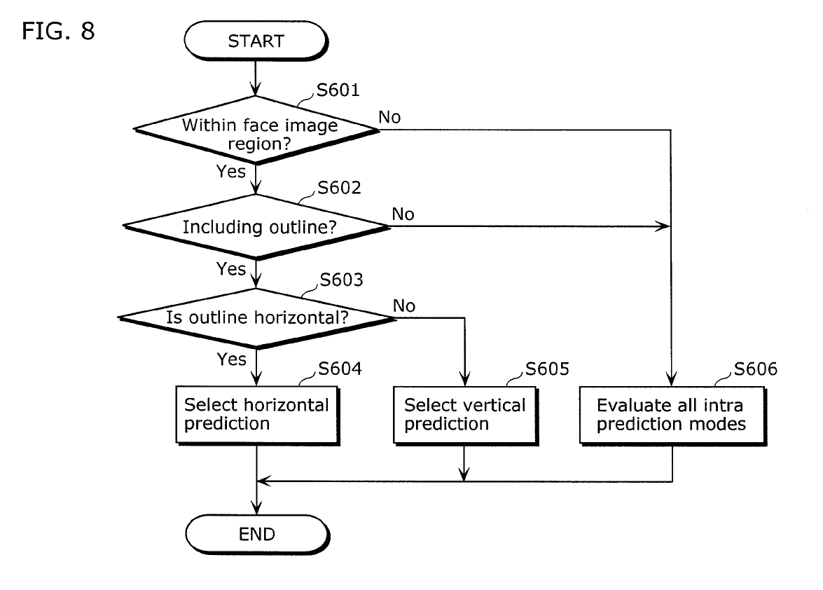

FIG. 8 is a flowchart of the processing performed by the image coding device 800 for selecting an intra prediction mode based on such face image region information. The following describes a method of selecting an intra prediction mode with reference to FIG. 8.

At Step S601, the intra prediction unit 809 determines whether or not a current block is included in a face image region. Assuming that a position of the current block is represented by coordinates (curr_x, curr_y) and a sizes of a width blk_w and a height blk_h, a determination equation is defined as the following Expression 1. In the following expressions, for a result of a division operation, a number after a decimal point is rounded down. When the current block satisfies the Equation 1, the intra prediction unit 809 determines that the current block is included in at least a part of the face image region 502. If the current block is included in the face image region 502, then the processing proceeds to Step S602. On the other hand, if the current block is not included in the face image region 502, the processing proceeds to Step S606.

(x/blk_w)*blk_w≦curr_x

and curr_≦((x+W)/blk_w)*blk_w

and (y/blk_h)*blk_h≦curr_y

and curr_y≦((y+H)/blk_h)*blk_h [Expression 1]

At Step S602, it is determined whether or not the current block includes a portion of an outline of the face image region 502. An mathematical expression for the determination is the following Expression 2. If the current block includes the portion of the outline, then the processing proceeds to Step S603. On the other hand, if the current block does not include the portion of the outline, then the processing proceeds to Step S606.

curr_x=(x/blk_w)*blk_w

or curr_x=((x+W)/blk_w)*blk_w

or curr_y=(y/blk_h)*blk_h

or curr_z =((y+H)/blk_h)* blk_h [Expression 2]

At Step S603, it is determined whether the portion of the outline included in the current block is in a horizontal direction or in a vertical direction. A mathematical expression for determining the horizontal direction is defined as the following Expression 3. A mathematical expression for determining the vertical direction is defined as the following Expression 4. If the portion of the outline is in a horizontal direction, then the processing proceeds to Step S604. On the other hand, if the portion of the outline is in a vertical direction, then the processing proceeds to Step S605.

curr_y=(y/blk_)*blk_h

or curr_y=((x+H)/blk_h)*blk_h [Expression 3]

curr_x=(y/blk_w)*blk_w

or curr_x=((x+W)/blk_w)* blk_w [Expression 4]

At Step S604, the intra prediction mode control unit 103 designates a horizontal prediction mode as an intra prediction mode of the current block, then instructs the selector 104 to select the horizontal prediction mode, and completes the designation processing.

At Step S605, the intra prediction mode control unit 103 designates a vertical prediction mode as an intra prediction mode of the current block, then instructs the selector 104 to select the vertical prediction mode, and completes the designation processing. Here, the intra prediction mode control unit 103 is an example of “the intra prediction mode selection unit is configured to: select a vertical prediction mode when the one of the blocks includes a portion of an outline of the region, the portion of the outline being vertical; and select a horizontal prediction mode when the one of the blocks includes the portion of the outline which is horizontal” in the first aspect of the present invention.

At Step S606, the intra prediction mode control unit 103 evaluates a differential value of each of all intra prediction modes, thereby select an appropriate intra prediction mode, and completes the designation processing.

The above-described designation processing makes it possible to appropriately select an intra prediction mode for a portion of an outline of the face image (or face image region), thereby preventing deterioration of image of the outline portion.

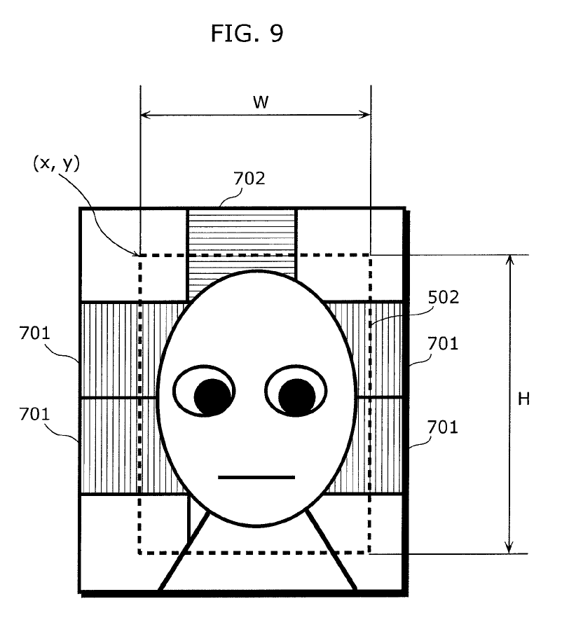

FIG. 9 is a diagram showing an enlarged face image region and how to select an intra prediction mode for a current block including a boundary of the face image region. Since a block 701 includes a vertical outline of a face image region, the vertical prediction mode is used for the block 701. Since a block 702 includes a horizontal outline of the face image region, the horizontal prediction mode is used for the block 702. In Embodiment 1, an intra prediction mode can be selected according to a direction of an outline of a face image region in units of blocks. Thereby, even when a block including a portion of an outline of a face image region has an edge of a background image prominent more than the outline portion, it is possible to prevent deterioration of image quality with the edge extended to a direction across the outline of the face image region.

The selector 104 selects an intra prediction mode unit having the prediction mode designated by the intra prediction mode control unit 103. In other words, the selector 104 selects one of the vertical intra prediction mode unit 105, the horizontal intra prediction mode unit 106, and the DC intra prediction mode unit 107. Thereby, the selected intra prediction mode unit performs intra prediction on the current block.

It should be noted that it has been described using the flowchart of the designation of an intra prediction mode that two kinds of prediction, vertical prediction and horizontal prediction, are selected for two directions of outlines of the face image region, a vertical direction and a horizontal direction, respectively. However, the prediction modes are not limited to these two modes, but it is possible to select another intra prediction mode according to a direction of a face image outline estimated from the face image region information. For example, it is also possible to detect an outline of a face by the face detection unit and then select an intra prediction mode according to a direction of a curb of the detected outline. In this case, an intra prediction mode having an angle most approximate to an angle of the outline in a current block including the outline of the face image. Then, the selected intra prediction mode is used to perform intra prediction on the current block. Here, the intra prediction mode control unit 103 is an example of “the intra prediction mode selection unit is configured to select, for the one of the blocks, one of the intra prediction modes which corresponds to a direction most approximate to a direction of a portion of an outline of the face detected by the object detection unit, when the one of the blocks includes the portion of the outline” in the first aspect of the present invention.

As described above, in Embodiment 1, the face image region information is used to control an intra prediction mode. Thereby, it is possible to select an appropriate intra prediction mode for an outline of a face image when a low bit-rate is used, thereby preventing prominent deterioration of image quality of the outline.

### Embodiment 2

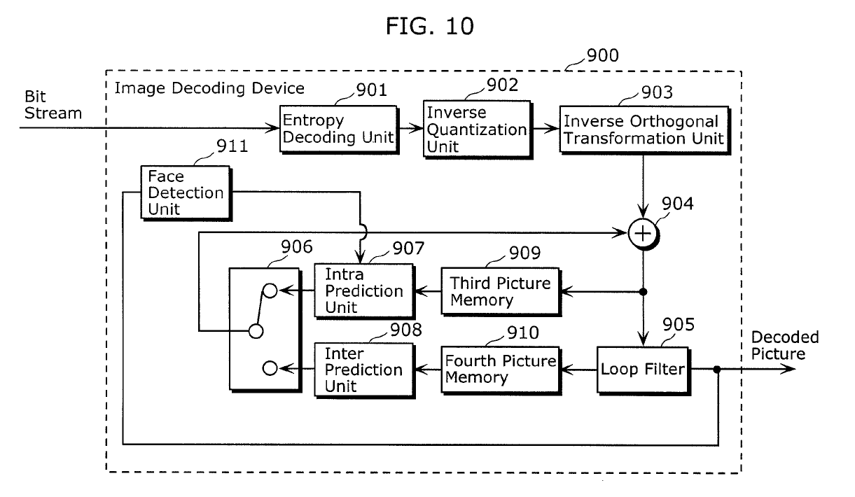

FIG. 10 is a block diagram of an image decoding device 900 according to Embodiment 2 of the present invention. The image decoding device 900 specifies a face region in an decoded picture immediately prior to a currently-decoding picture (hereinafter, a “current picture”) in input pictures generated by decoding a coded stream. Face image region information indicating the specified face region is used for the current picture. If a current block in the current picture includes a part of a vertical boundary of the face region, intra prediction is performed on the current block at a vertical intra prediction mode. If a current block in the current picture includes a part of a horizontal boundary of the face region, intra prediction is performed on the current block at a horizontal intra prediction mode. Thereby, the image decoding device 900 generates an intra prediction image with less deterioration of image quality. Here, the image decoding device 900 does not consider an intra prediction mode indicated in the current block in the coded stream. This image decoding device 900 includes an entropy decoding unit 901, an inverse quantization unit 902, an inverse orthogonal transformation unit 903, an adder 904, a loop filter 905, a selector 906, an intra prediction unit 907, an inter prediction unit 908, a third picture memory 909, a fourth picture memory 910, and a face detection unit 911.

The entropy decoding unit 901 performs entropy decoding on a coded bit-stream received by the image decoding device 900. The inverse quantization unit 902 performs inverse quantization on the quantized coefficients generated by the entropy decoding, thereby generating orthogonal transformation coefficients. The inverse orthogonal transformation unit 903 performs inverse orthogonal transformation on the orthogonal transformation coefficients generated by the inverse quantization, thereby generating a differential image. The adder 904 adds the differential image provided from the inverse orthogonal transformation unit 903 with a prediction image provided from the intra prediction unit 907 or the inter prediction unit 908. As a result, a locally-decoded image is generated. On the locally-decoded image generated by the adder 904, the loop filter 905 performs de-blocking filtering and the like using image interpolation and the like. If the locally-decoded image applied with the de-blocking filtering and the like by the loop filter 905 is included in a picture to be applied with inter prediction, the locally-decoded images are accumulated in the fourth picture memory 910 to be provided to the outside as a decoded picture. If the locally-decoded image generated by the adder 904 is included in a picture to be applied with intra prediction, the locally-decoded images are accumulated directly in the third picture memory 909 without being applied with any processing and also applied with de-blocking filtering and the like by the loop filter 905 to be provided to the outside as a decoded picture.

The picture stored in the third picture memory 909 is read out by the intra prediction unit 907, and applied with intra prediction based on the face image region information generated by the face detection unit 911. In more detail, if a current block includes a part of a vertical boundary of the face image region, then an intra prediction mode for a vertical direction is used for the current block regardless of the intra prediction mode used in the coding. On the other hand, if a current block includes a part of a horizontal boundary of the face image region, then an intra prediction mode for a horizontal direction is used for the current block regardless of the intra prediction mode used in the coding. The face detection unit 911 is an example of “an object detection unit configured to detect an object image from a decoded picture generated from input coded data”, “the object detection unit is configured to detect a face from the decoded picture as the object image”, and “the object detection unit is further configured to generate region information indicating a region including the detected object image in the decoded picture” in the second aspect of the present invention. The face detection unit 911 specifies a face image region in a decoded image provided from the loop filter 905 and generates face image region information indicating the specified face image region to be provided to the intra prediction unit 907. If a current block has been applied with intra prediction, then the selector 906 selects the intra prediction unit 907 and provides a prediction image received from the intra prediction unit 907 to the adder 904. On the other hand, if a current block has been applied with inter prediction, then the selector 906 selects the inter prediction unit 908 and provides a prediction image received from the inter prediction unit 908 to the adder 904.

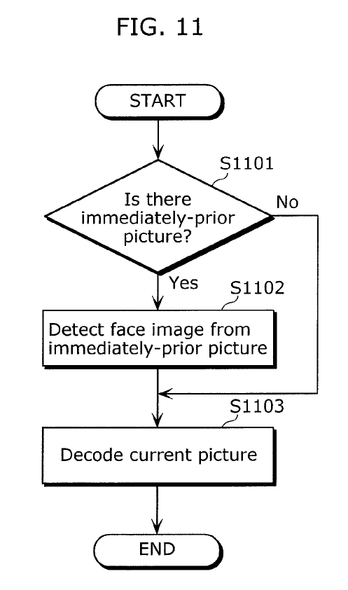

FIG. 11 is a flowchart of processing performed by the image decoding device 900 to perform intra prediction according to a direction of a boundary of a face image region. Firstly, the intra prediction unit 907 determines whether or not there is a decoded picture immediately prior to a current picture (S1101). If there is such an immediately-prior decoded picture (Yes at S1101), the face detection unit 911 detects and specifies a face image region from the immediately-prior decoded picture (S1102). Moreover, the face detection unit 911 generates face image region information indicating the detected face image region, and provides the face image region information to the intra prediction unit 907. The intra prediction unit 907 is an example of “an intra prediction unit configured to perform intra prediction of the current block at the intra prediction mode selected by the intra prediction mode selection unit” in the second aspect of the present invention. The intra prediction unit 907 determines a position, an area, and the like of the face image region of the immediately-prior picture based on the face image region information provided from the face detection unit 911, and then performs intra prediction on the current picture at intra prediction modes depending on an outline of the face image region (S1103). In other words, if a current block in the current picture includes a part of a vertical boundary of the face image region, then the vertical intra prediction mode unit 105 is selected to perform the intra prediction on the current block. On the other hand, if a current block includes a part of a horizontal boundary of the face image region, then the horizontal intra prediction mode unit 106 is selected to perform the intra prediction on the current block. Here, the intra prediction unit 907 is an example of “the intra prediction mode selection unit is configured to select the intra prediction mode assuming that an outline of the region indicated by the region information is the outline of the object image” in the second aspect of the present invention. If the current block does not include the boundary of the face image region, then intra prediction is performed on the current block according to a prediction mode indicated in the coded stream for the current block. In other words, the intra prediction mode control unit is an example of “the intra prediction mode selection unit is configured to select the intra prediction mode assuming that the outline of the region indicated by the region information is the outline of the object image” and “the intra prediction mode selection unit is configured to: select a vertical prediction mode when the current block is co-located with a block which is in the decoded picture and includes a substantially-vertical boundary of the region, and select a horizontal prediction mode when the current block is co-located with a block which is in the decoded picture and includes a substantially-horizontal boundary of the region” in the second aspect of the present invention.

It should be noted that it has been described in Embodiment 2 with reference to the flowchart of the designation of an intra prediction mode that selection is performed between the vertical prediction and the horizontal prediction. However, also in Embodiment 2, the prediction modes are not limited to these two modes, but it is possible to select another intra prediction mode according to a direction of a face image outline estimated from the face image region information. For example, it is also possible to detect an outline of a face by the face detection unit and then select an intra prediction mode according to a direction of a curb of the detected outline. In this case, the selected intra prediction mode has an angle most approximate to an angle of a portion of the outline in a current block including the portion of the outline of the face image, and the current block is applied with intra prediction using the selected intra prediction mode. Here, the intra prediction mode control unit 103 is an example of “the intra prediction mode selection unit is configured to select, for the current block in the current picture, an intra prediction mode corresponding to a direction most approximate to a direction of a portion of an outline of the face detected by the object detection unit, when the current block is co-located with a block which is in the decoded picture and includes the portion of the outline” in the second aspect of the present invention.

It should also be noted that it has been described in Embodiment 2 that the face image region is detected from a decoded picture immediately prior to a current picture including a current block and that an intra prediction mode is designated for the current block based on face image region information indicating the detected face image region. However, the present invention is not limited to the above. For example, it is also possible that an image coding device detects an outline of a face image, thereby generates face image region information, and adds the generated face image region information as tag information to a picture header in a coded stream. Here, the face detection unit 911 is an example of “the object detection unit is configured to (i) extract, from a header in the coded data, region information indicating a region including the object image in the current picture, and (ii) detect the object image in the current picture according to the extracted region information” in the second aspect of the present invention. In this case, the image decoding device may receive the face image region information from the header of the coded stream, and selects, for the current block including a portion of an outline of the face image region, an intra prediction mode corresponding to a direction of the portion of the outline. Here, the intra prediction mode control unit 103 is an example of “the intra prediction mode selection unit is configured to select, for the current block in the current picture, the intra prediction mode corresponding to the direction of the portion of the outline of the object image detected by the object detection unit” in the second aspect of the present invention. It should be noted that it is also possible that the header of the coded stream includes information indicating an intra prediction mode to be selected for the current block including the portion of the outline of the face image information.

It should also be noted that functional elements in the image coding device 800 are generally implemented into a LSI which is an integrated circuit. These may be integrated separately, or a part or all of them may be integrated into a single chip.

Here, the integrated circuit is referred to as a LSI, but the integrated circuit can be called an IC, a system LSI, a super LSI or an ultra LSI depending on their degrees of integration.

It should also be noted that the technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

### INDUSTRIAL APPLICABILITY

The image coding device according to the present invention has a unit detecting a face image and controlling an intra prediction mode based on a result of the detection. As a result, image quality deterioration due to a low bit-rate can be prevented. Therefore, the image coding device is useful in a network camera or a security camera. Furthermore, the present invention is useful as an image lo decoding device for preventing image quality deterioration of a periphery of the face due to a low bit-rate

1. An image coding device performing prediction coding including intra prediction, said image coding device comprising:
an object detection unit configured to detect an object image from an input picture;
an intra prediction mode selection unit configured to (i) divide the input picture into blocks, and (ii) select, for one of the blocks, one of intra prediction modes which corresponds to a direction of a portion of an outline of the object image, when the one of the blocks includes the portion of the outline; and
an intra prediction unit configured to perform intra prediction on the one of the blocks at the one of the intra prediction modes which is selected by said intra prediction mode selection unit.

2. The image coding device according to claim 1,
wherein said object detection unit is configured to detect a face as the object image.

3. The image coding device according to claim 1,
wherein said object detection unit is further configured to generate region information indicating a region including the detected object image in the input picture, and
said intra prediction mode selection unit is configured to select the one of the intra prediction modes assuming that an outline of the region indicated by the region information is the outline of the object image.

4. The image coding device according to claim 3,
wherein the region information indicates (i) coordinates of a starting point of the region and (ii) a size of the region.

5. The image coding device according to claim 1,
wherein a region including the object image is a rectangle, and
said intra prediction mode selection unit is configured to:
select a vertical prediction mode when the one of the blocks includes a portion of an outline of the region, the portion of the outline being vertical; and
select a horizontal prediction mode when the one of the blocks includes the portion of the outline which is horizontal.

6. The image coding device according to claim 2,
wherein said intra prediction mode selection unit is configured to select, for the one of the blocks, one of the intra prediction modes which corresponds to a direction most approximate to a direction of a portion of an outline of the face detected by said object detection unit, when the one of the blocks includes the portion of the outline.

7. An image decoding device performing prediction decoding including intra prediction, said image decoding device comprising:
an object detection unit configured to detect an object image from a decoded picture generated from input coded data;
an intra prediction mode selection unit configured to select, for a current block in a current picture, an intra prediction mode corresponding to a direction of a portion of an outline of the object image detected from the decoded picture, when the current block is co-located with a block which is in the decoded picture and includes the portion of the outline; and
an intra prediction unit configured to perform intra prediction of the current block at the intra prediction mode selected by said intra prediction mode selection unit.

8. The image decoding device according to claim 7,
wherein said object detection unit is configured to detect a face from the decoded picture as the object image.

9. The image decoding device according to claim 8,
wherein said object detection unit is further configured to generate region information indicating a region including the detected object image in the decoded picture, and
said intra prediction mode selection unit is configured to select the intra prediction mode assuming that an outline of the region indicated by the region information is the outline of the object image.

10. The image decoding device according to claim 9,
wherein the region information indicates (i) coordinates of a starting point of the region and (ii) a size of the region, the region being a rectangle, and
said intra prediction mode selection unit is configured to select the intra prediction mode assuming that the outline of the region indicated by the region information is the outline of the object image.

11. The image decoding device according to claim 9,
wherein said intra prediction mode selection unit is configured to:
select a vertical prediction mode when the current block is co-located with a block which is in the decoded picture and includes a substantially-vertical boundary of the region, and
select a horizontal prediction mode when the current block is co-located with a block which is in the decoded picture and includes a substantially-horizontal boundary of the region.

12. The image decoding device according to claim 8,
wherein said intra prediction mode selection unit is configured to select, for the current block in the current picture, an intra prediction mode corresponding to a direction most approximate to a direction of a portion of an outline of the face detected by said object detection unit, when the current block is co-located with a block which is in the decoded picture and includes the portion of the outline.

13. The image decoding device according to claim 7,
wherein said object detection unit is configured to (i) extract, from a header in the coded data, region information indicating a region including the object image in the current picture, and (ii) detect the object image in the current picture according to the extracted region information, and
said intra prediction mode selection unit is configured to select, for the current block in the current picture, the intra prediction mode corresponding to the direction of the portion of the outline of the object image detected by said object detection unit.

14. An integrated circuit performing prediction coding including intra prediction, said integrated circuit comprising:
an object detection unit configured to detect an object image from an input picture;
an intra prediction mode selection unit configured to (i) divide the input picture into blocks, and (ii) select, for one of the blocks, one of intra prediction modes which corresponds to a direction of a portion of an outline of the object image, when the one of the blocks includes the portion of the outline; and
an intra prediction unit configured to perform intra prediction on the one of the blocks at the one of the intra prediction modes which is selected by said intra prediction mode selection unit.

15. An integrated circuit performing prediction decoding including intra prediction, said integrated circuit comprising:
an object detection unit configured to detect an object image from a decoded picture generated from input coded data;
an intra prediction mode selection unit configured to select, for a current block in a current picture, an intra prediction mode corresponding to a direction of a portion of an outline of the object image detected from the decoded picture, when the current block is co-located with a block which is in the decoded picture and includes the portion of the outline; and
an intra prediction unit configured to perform intra prediction of the current block at the intra prediction mode selected by said intra prediction mode selection unit.

16. An image coding method of performing prediction coding including intra prediction, said image coding method comprising:
detecting an object image from an input picture;
(i) dividing the input picture into blocks, and (ii) selecting, for one of the blocks, one of intra prediction modes which corresponds to a direction of a portion of an outline of the object image, when the one of the blocks includes the portion of the outline; and
performing intra prediction on the one of the blocks at the one of the intra prediction modes which is selected in said selecting.

17. An image decoding method of performing prediction decoding including intra prediction, said image decoding method comprising:
detecting an object image from a decoded picture generated from input coded data;
selecting, for a current block in a current picture, an intra prediction mode corresponding to a direction of a portion of an outline of the object image detected from the decoded picture, when the current block is co-located with a block which is in the decoded picture and includes the portion of the outline; and
performing intra prediction of the current block at the intra prediction mode selected in said selecting.

18. A program recorded in a computer-readable recording medium, said program causing a computer to execute:
detecting, by an object detection unit, an object image from an input picture; (i) dividing, by an intra prediction mode selection unit, the input picture into blocks, and (ii) selecting, by the intra prediction mode selection unit, for one of the blocks, one of intra prediction modes which corresponds to a direction of a portion of an outline of the object image, when the one of the blocks includes the portion of the outline; and performing, by an intra prediction unit, intra prediction on the one of the blocks at the one of the intra prediction modes which is selected in said selecting.

19. A program recorded in a computer-readable recording medium, said program causing a computer to execute:
detecting, by an object detection unit, an object image from a decoded picture generated from input coded data; selecting, by an intra prediction mode selection unit, for a current block in a current picture, an intra prediction mode corresponding to a direction of a portion of an outline of the object image detected from the decoded picture, when the current block is co-located with a block which is in the decoded picture and includes the portion of the outline; and performing, by an intra prediction unit, intra prediction of the current block at the intra prediction mode selected in said selecting.
